(19) United States
(12) Patent Application Publication
(10) Pub. No.: US 2026/0021773 A1
(43) Pub. Date: Jan. 22, 2026

(54) STORAGE COMPARTMENT ARRANGED ADJACENT BOX SIDE STEP

(71) Applicant: Ford Global Technologies, LLC, Dearborn, MI (US)

(72) Inventors: Matthew Craddock, Dearborn, MI (US); John Galin, Mill Valley, CA (US); Jeremy R. Leng, Ypsilanti, MI (US)

(21) Appl. No.: 18/775,430

(22) Filed: Jul. 17, 2024

(51) Int. Cl. B60R 9/06; B60R 3/02

(52) U.S. Cl. CPC B60R 9/065; B60R 3/02

(57) ABSTRACT

A motor vehicle may include a cargo box including an outer panel, a box side step, and a storage compartment arranged adjacent the box side step. An interior of the storage compartment may be selectively covered and uncovered by a door. The door may be moveable between a closed position and an open position. Further, relative to when the door is in the closed position, at least a portion of a laterally outward surface of the door may be recessed laterally inward of the outer panel.

### TECHNICAL FIELD

This disclosure relates to a storage compartment arranged adjacent a box side step of a motor vehicle, such as a pickup truck, and various corresponding accessories.

### BACKGROUND

Pickup trucks typically include a latching tailgate that swings between an upright, closed position and a horizontal, open position. When in the closed position, the tailgate is latched to a cargo box. When open, the tailgate provides access to the cargo box from the rear of the pickup truck. Some pickup trucks incorporate a side step adjacent a side of the cargo box which can be used by a user to access the cargo box from the side of the pickup truck.

### SUMMARY

In some aspects, the techniques described herein relate to a motor vehicle, including: a cargo box including an outer panel; a box side step; and a storage compartment arranged adjacent the box side step, wherein an interior of the storage compartment is selectively covered and uncovered by a door, wherein the door is moveable between a closed position and an open position, wherein, relative to when the door is in the closed position, at least a portion of a laterally outward surface of the door is recessed laterally inward of the outer panel.

In some aspects, the techniques described herein relate to a motor vehicle, wherein, relative to when the door is in the closed position: a first portion of the laterally outward surface of the door is recessed laterally inward of the outer panel, and a second portion of the laterally outward surface of the door is substantially flush with the outer panel.

In some aspects, the techniques described herein relate to a motor vehicle, wherein the first portion exhibits a length greater than a length of the box side step.

In some aspects, the techniques described herein relate to a motor vehicle, wherein: the box side step projects partially laterally outward of a portion of the outer panel adjacent the box side step, and relative to when the door is in the closed position, the first portion is recessed laterally inward of the outer panel such that an entire uppermost surface of the box side step is exposed.

In some aspects, the techniques described herein relate to a motor vehicle, further including a shelf configurable between a first configuration in which the shelf can be used to support items within the storage compartment, and a second configuration in which the shelf can be stowed.

In some aspects, the techniques described herein relate to a motor vehicle, wherein: the storage compartment includes a shelf support configurable between a first configuration in which the shelf support projects outward relative to a side wall of the storage compartment such that a shelf is able to rest upon the shelf support when the shelf is in the first configuration, and a second configuration in which the shelf support is substantially flush with the side wall.

In some aspects, the techniques described herein relate to a motor vehicle, wherein: the side wall is a first side wall of the storage compartment and the shelf support is a first shelf support, and the storage compartment further includes a second shelf support vertically aligned with the first shelf support and configurable between a first configuration in which the second shelf support projects outward relative to a second side wall of the storage compartment such that the shelf is able to rest upon the second shelf support when the shelf is in the first configuration, and a second configuration in which the second shelf support is substantially flush with the second side wall.

In some aspects, the techniques described herein relate to a motor vehicle, wherein: a rear wall of the storage compartment includes a slot, and when the shelf is in the first configuration and supported on the first and second shelf supports, a rear edge of the shelf is received in the slot.

In some aspects, the techniques described herein relate to a motor vehicle, wherein: the storage compartment includes a side wall including a sub-storage compartment defined by an opening in the side wall, the opening has a perimeter, and a portion of the sub-storage compartment extends beneath the perimeter.

In some aspects, the techniques described herein relate to a motor vehicle, wherein: the storage compartment is defined by an opening in the outer panel, the opening has a perimeter, and a portion of the storage compartment extends beneath the perimeter.

In some aspects, the techniques described herein relate to a motor vehicle, wherein an accessory is configured to fit within the storage compartment, and wherein a portion of the accessory is configured to fit within the portion of the storage compartment below the perimeter.

In some aspects, the techniques described herein relate to a motor vehicle, wherein the accessory is one of a portable battery, a tool box, and a water tank.

In some aspects, the techniques described herein relate to a motor vehicle, wherein: a seal extends around the perimeter, and a laterally inward surface of the door is configured to press against the seal when the door is in the closed position.

In some aspects, the techniques described herein relate to a motor vehicle, further including a divider configurable between a first configuration in which the divider can be used to separate items within the storage compartment, and a second configuration in which the divider can be stowed in a recess in a side wall of the storage compartment.

In some aspects, the techniques described herein relate to a motor vehicle, wherein the storage compartment includes a battery charging port.

In some aspects, the techniques described herein relate to a motor vehicle, wherein the storage compartment includes a peg board.

In some aspects, the techniques described herein relate to a motor vehicle, wherein a laterally inward surface of the door includes a slot configured to store items.

In some aspects, the techniques described herein relate to a motor vehicle, wherein a laterally inward surface of the door supports a folding table configurable between a first configuration in which the table is configured for use as a table and a second configuration in which the table is stowed.

In some aspects, the techniques described herein relate to a motor vehicle, including: a cargo box including an outer panel; a box side step; a storage compartment arranged adjacent the box side step, wherein the storage compartment is selectively covered and uncovered by a door, wherein the door is moveable between a closed position and an open position, wherein the storage compartment is defined by an opening in the outer panel, wherein the opening has a perimeter, and wherein a portion of the storage compartment extends beneath the perimeter.

In some aspects, the techniques described herein relate to a method including: opening a door to uncover a storage compartment in a cargo box of a motor vehicle; and unfolding a table mounted to a laterally inward surface of the door.

### BRIEF DESCRIPTION OF THE DRAWINGS

FIG. 1 is a side view of a motor vehicle including a box side step and a storage compartment adjacent the box side step. In FIG. 1, the vehicle is a pickup truck.

FIG. 2 is a perspective view illustrating additional detail of the storage compartment and the box side step. In FIG. 2, a door of the storage compartment is in the closed position.

FIG. 3 is a perspective view illustrating additional detail of the storage compartment and the box side step. In FIG. 3, the door of the storage compartment is in the open position.

FIG. 4 is a view of the storage compartment including an example latch assembly.

FIG. 5 illustrates an example divider arrangement.

FIG. 6 illustrates the example dividers in a stowed configuration.

FIG. 7 illustrates an example shelving arrangement.

FIG. 8 illustrates the example shelves in a stowed configuration.

FIG. 9 illustrates an example shelf relative to example shelf supports.

FIG. 10 is a view similar to FIG. 9 but illustrates the example shelf supports in a stowed configuration.

FIG. 11 illustrates an example latch assembly relative to an example shelf.

FIG. 12 illustrates an example sub-compartment within the storage compartment.

FIG. 13 illustrates the storage compartment including a peg board and a toolbox.

FIG. 14 illustrates the storage compartment including a portable battery and charging ports.

FIG. 15 illustrates the storage compartment including a water tank.

FIG. 16 illustrates the storage compartment including a folding table. In FIG. 16, the folding table is in a use configuration.

FIG. 17 is representative of an example movement of the folding table when moving from a stowed configuration to an intermediate configuration.

FIG. 18 is a view of a pivotable connection of the table relative to a laterally inner surface of a door.

FIG. 19 is representative of an interface of two panels of the table when the table is in a use configuration.

### DETAILED DESCRIPTION

This disclosure relates to a storage compartment arranged adjacent a box side step of a motor vehicle, such as a pickup truck, and various corresponding accessories. The storage compartment of this disclosure provides users with convenient storage for various items, including tow straps, ropes, wheel chocks, chains, etc., without taking up space in the cargo bed or passenger compartment of the motor vehicle. The storage compartment is also located adjacent a box side step, and is configured so as to not inhibit normal use of the box side step. The configuration of the storage compartment is such that the box side step may be relatively large while minimizing the amount that the box side step projects laterally outwards of the vehicle. The storage compartment also adds to the overall aesthetic appeal of the motor vehicle. The storage compartment also cooperates with a number of accessories, each of which provides the storage compartment with added functionality and corresponding benefits. These and other benefits will be appreciated from the following description.

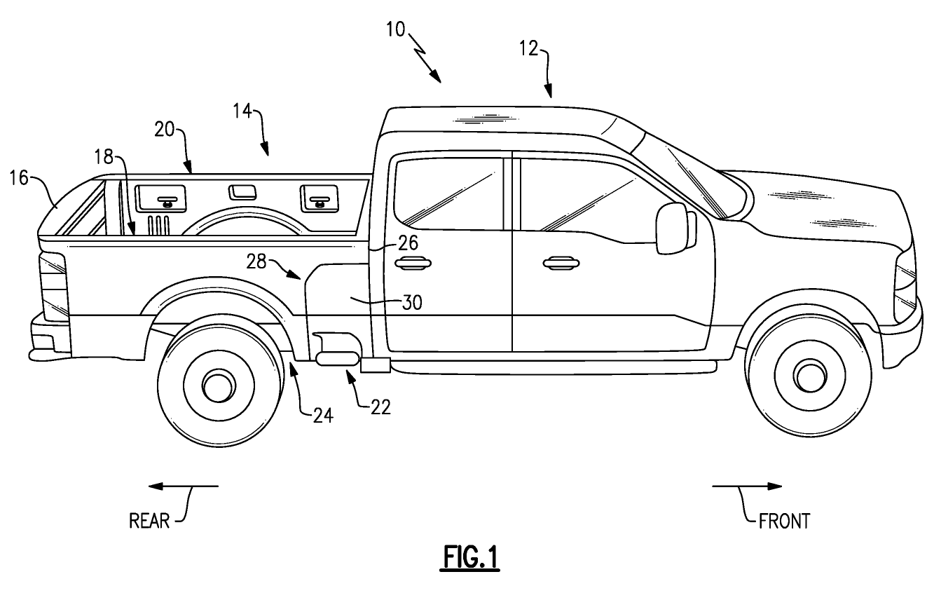

FIG. 1 illustrates a motor vehicle 10 (“vehicle 10”), which in this example is a pickup truck. The vehicle 10 includes a passenger cabin 12 and a cargo box 14 rearward of the passenger cabin 12. The “front” and “rear” directions are labeled in FIG. 1 for ease of reference. The vehicle 10 further includes a tailgate 16 configured to move between an open position and a closed position to allow access to the cargo box 14 from the rear of the vehicle 10. Along the sides, the cargo box 14 includes first and second side rails 18, 20. When in the closed position, the tailgate 16 is configured to latch relative to the first and second side rails 18, 20. While a pickup truck is shown in FIG. 1, this disclosure extends to other types of vehicles.

In this disclosure, the vehicle 10 includes at least one box side step, which is a step that can be used by a user to access the cargo box 14 from the side of the vehicle 10. One box side step 22 is visible in FIG. 1. The box side step 22 is arranged adjacent, and in particular is attached to, the first side rail 18. It should be understood that the second side rail 20 may also include a substantially similar box side step. The term box side step refers to the surface where a user places their foot/shoe to access the cargo box 14 and the corresponding components of the box side step. In this sense, the term box side step refers to an overall box side step assembly.

The box side step 22, in this example, is forward of a rear wheel well 24 of the vehicle 10. The box side step 22 is also rearward of a front panel 26 of the cargo box 14. The box side step 22 may be vertically aligned with at least a rear portion of a running board of the vehicle 10, which may increase the ease of using the box side step 22.

The vehicle 10 further includes a storage compartment 28 arranged adjacent the box side step 22. The storage compartment 28 is selectively covered and uncovered by a door 30 moveable between a closed position and an open position to reveal the interior of the storage compartment 28, which can store items therein. In FIG. 1, the door 30 is in the closed position.

The storage compartment 28 is arranged adjacent the box side step 22. While one storage compartment 28 is shown in FIG. 1, it should be understood that another storage compartment may be arranged adjacent a box side step on the second side rail 20 of the vehicle 10. As will be discussed below, if two such storage compartments are present on the motor vehicle 10, the volume capacity of the two storage compartments may differ. In particular, a height of the storage compartment may vary if provided adjacent a port of the vehicle, such as a charging port or a fuel door.

In this disclosure, the first and second side rails 18, 20 include inner and outer panels that are laterally spaced-apart from one another in a direction normal to the centerline of the vehicle 10. The “in” and “out” directions are labeled in some drawings, and are representative of laterally inward and laterally outward directions, respectively. The laterally inward and laterally outward directions are normal to the centerline of the vehicle 10.

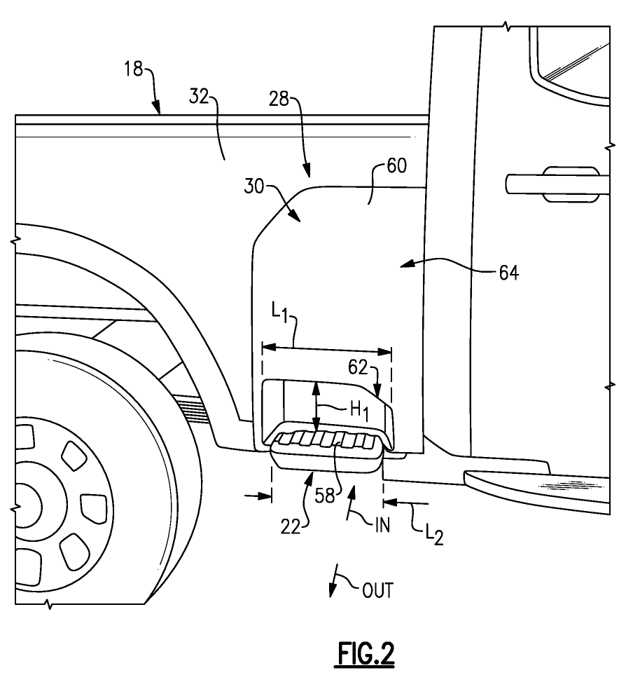

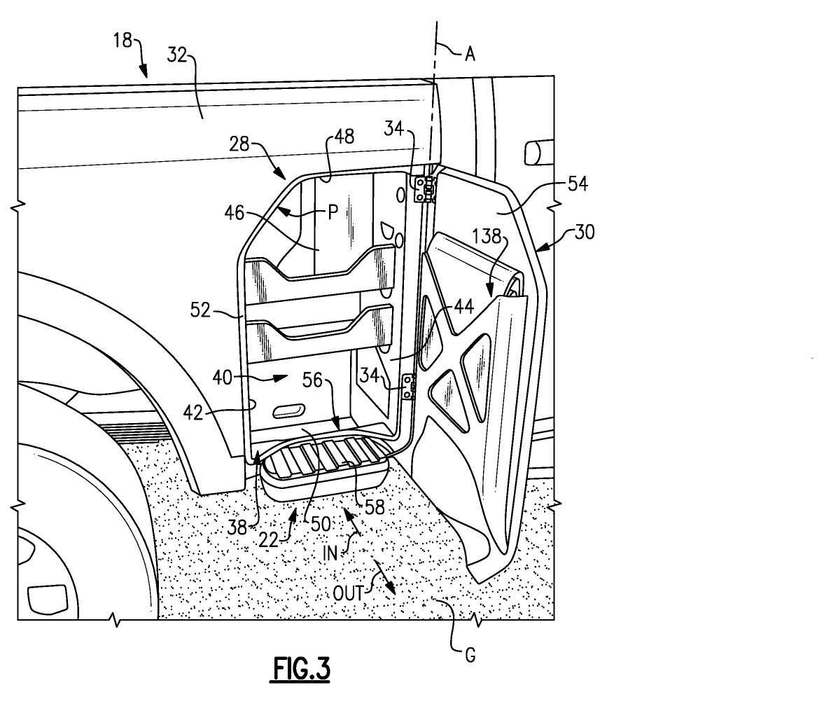

FIGS. 2 and 3 illustrate the box side step 22 and the storage compartment 28 in more detail, with the door 30 in the closed position and open position, respectively. In FIGS. 2 and 3, the outer panel 32 of the first side rail 18 is shown. The outer panel 32 provides an outer body panel of the vehicle 10.

The door 30 is moveable relative to the outer panel 32. In particular, the door 30 is rotatable about an axis A substantially perpendicular to a ground surface G adjacent the vehicle 10 via hinge assemblies 34. The door 30 is rotatable about an angle of substantially 90° when moving between the closed position and the open position. A latch assembly 36 (FIG. 4) may be configured to selectively hold the door 30 in the closed position. The latch assembly 36 may be provided by a push-to-open latch mechanism, such that the door 30 is configured to open when a force is applied to the door 30 so as to activate a mechanical push-to-open latch. A lock assembly may cooperate with the latch assembly 36 and/or another portion of the door 30 to selectively lock the door 30 in the closed position. A user may selectively unlock the lock assembly to permit the door 30 to move to the open position using a button within the passenger cabin 12, on a keyfob, or on a mobile device, as examples.

When the door 30 is open, as in FIG. 3, the door 30 uncovers the interior of the storage compartment 28. In particular, the door 30 uncovers an opening 38 that leads into an interior cavity 40 within which items can be stored. The opening 38 is sized and shaped to correspond to the size and shape of the door 30. The interior cavity 40 is arranged within the first side rail 18, and in particular is arranged laterally between the outer panel 32 and an inner panel of the first side rail 18. The interior cavity 40 is bound by a first side wall 42, a second side wall 44, a rear wall 46 generally opposite the opening 38 and spanning between the first and second side walls 42, 44, a top wall 48, and a bottom wall 50. When the door 30 is closed, the door 30 and the walls 42, 44, 46, 48, 50 provide boundaries for the interior cavity 40 of the storage compartment 28.

The opening 38 exhibits a perimeter P. The perimeter P extends about substantially the entirety of the opening 38. In this example, a seal 52 spans about the entirety of the perimeter P. The seal 52 may be made of an elastomeric material. When the door 30 is closed, a laterally inward surface 54 (relative to when the door 30 is closed) of the door 30 is configured to press against the seal 52 to resist ingress of fluid, for example, relative to the storage compartment 28.

In this example, a portion of the storage compartment 28, namely a portion of the interior cavity 40, projects beneath the perimeter P. Specifically, the bottom wall 50 is vertically spaced-below a bottom of the perimeter P. In this way, the storage compartment 28 defines a vertical lip 56 that serves to retain items within the storage compartment 28.

The box side step 22 is configured to support a user while a foot of the user is placed on the box side step 22, for example, to facilitate access to items in or near the cargo box 14. The box side step 22 in this example is arranged vertically beneath the perimeter P. In this example, the uppermost surface 58 of the box side step 22 includes a textured top surface. The box side step 22 is configured such that only a portion of the uppermost surface 58 projects laterally outward of an adjacent portion of the outer panel 32.

The laterally outward surface 60 (relative to when the door 30 is closed) of the door 30, in this disclosure, is configured to facilitate access to the box side step 22. In particular, at least a portion of the laterally outward surface 60 is recessed laterally inward of the outer panel 32 when the door 30 is in the closed position.

With reference to when the door 30 is in the closed position of FIG. 2, the laterally outward surface 60 includes a first portion 62 recessed laterally inward of the outer panel 32. Further, a second portion 64 of the laterally outward surface 60 is substantially flush with the outer panel 32. In this example, the second portion 64 is arranged above the first portion 62, forward of the first portion 62, and rearward of the first portion 62. The second portion 64 is not beneath the first portion 62.

The first portion 62 includes a height H1 and a length L1. The height H1 corresponds to a height of a standard foot of a user. The length L1 is greater than a length L2 of the box side step 22 in this example. The first portion 62 is recessed by a depth D (FIG. 4) relative to the second portion 64. In this way, when the door 30 is closed, an entirety of the uppermost surface 58 of the box side step 22 is exposed such that a user can place their foot on the uppermost surface 58. By providing the door 30 with the recessed first portion 62, the area of the uppermost surface 58 of the box side step 22 can be relatively large while minimizing the amount that the box side step 22 projects laterally outward of the outer panel 32.

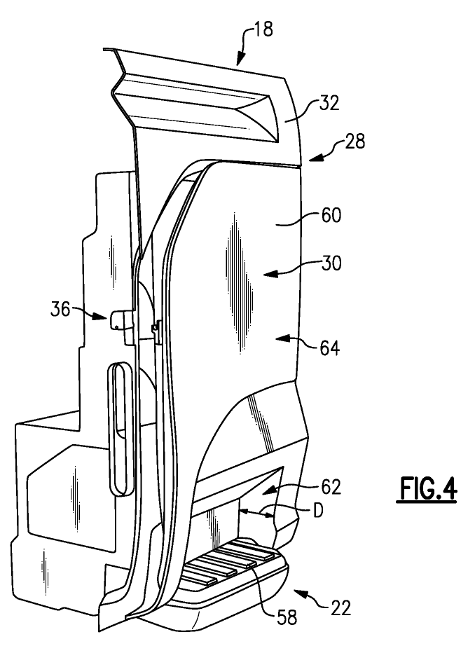

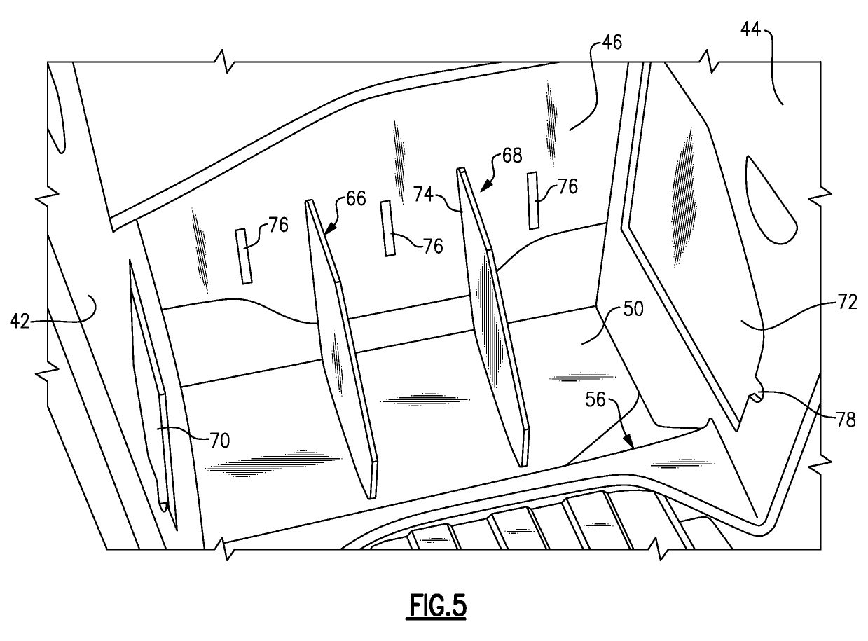

An aspect of this disclosure relates to dividers configured to divide the interior cavity 40 of the storage compartment 28. FIGS. 5 and 6 illustrates two example dividers 66, 68, each of which are configurable between a first configuration (FIG. 5) in which the dividers 66, 68 can be used to separate items within the storage compartment 28 on opposite sides of the respective divider 66, 68, and a second configuration (FIG. 6) in which the dividers 66, 68 can be stowed in a recess 70, 72 in a respective one of the first and second side walls 42, 44 of the storage compartment 28. With reference to divider 68, the divider 68 is essentially a wall configured to extend between the rear wall 46 and the vertical lip 56. The divider 68 is configured to sit on the bottom wall 50. A rear edge 74 (relative to when the divider 68 is in the first configuration) of the divider 68 is received in one of a plurality of slots 76 in the rear wall 46. The interface between the rear edge 74 and the slots 76 serves to maintain a position of the divider 68. There are a plurality of slots 76 spaced-apart from one another along the rear wall 46. A user can select one of the slots 76 to receive the rear edge 74 of the divider 68 depending on the needs of the user. The recess 72 is sized and shaped substantially similar to the size and shape of the divider 68. The divider 68 is configured to snap-into the recess 72 when the divider 68 is stowed, in one example. As shown in FIG. 6, when the divider 68 is in the recess 72, the divider 68 is substantially flush with the second wall 44. The recess 72 includes an access portion 78 configured such that a user can place their finger or thumb within the access portion 78 to retrieve the divider 68 from the recess 72. While the divider 68 and recess 72 have been described in detail, the divider 66 and recess 70 are configured similarly. While the storage compartment 28 includes two dividers and two recesses, this disclosure extends to configurations with one or more dividers and recesses.

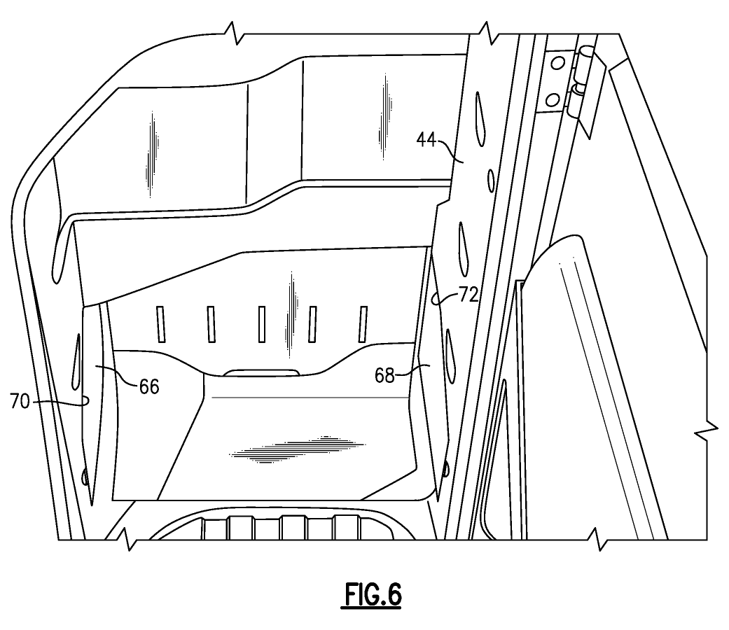

Another aspect of this disclosure relates to shelves of the storage compartment 28. In this example, the storage compartment 28 includes two shelves 80, 82, as shown in FIG. 7. The shelf 80 will be described in more detail. The shelf 82 is arranged substantially similarly. While two shelves are shown, this disclosure extends to configurations with one or more shelves.

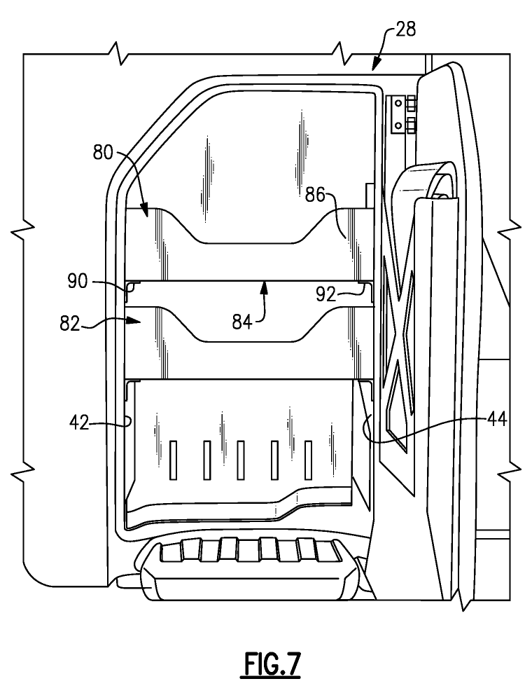

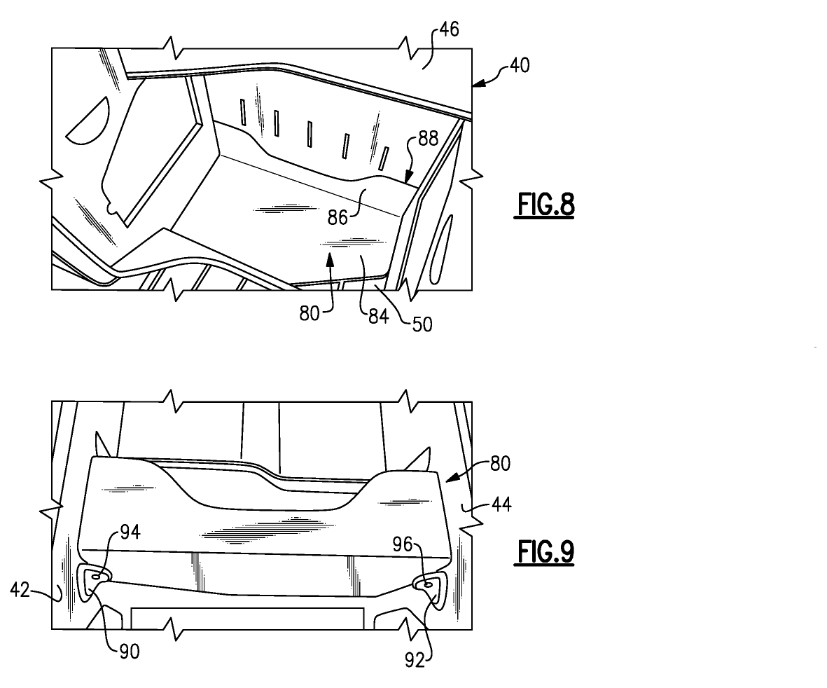

The shelf 80 is configurable between a first configuration (FIG. 7) in which the shelf 80 can be used to support items within the storage compartment 28, and a second configuration (FIG. 8) in which the shelf 80 can be stowed. The shelf 80 includes a base wall 84 and a front wall 86 (relative to when the shelf 80 is in the first configuration). When the shelf 80 is in the first configuration, the front wall 86 faces laterally outward and the base wall 84 provides a bottom wall of the shelf 80 and is configured to support items placed on the shelf 80. In the second configuration, the shelf 80 is configured to nest relative to the shelf 82, and both shelves 80, 82 are received in a recess 88 adjacent a bottom of the interior cavity 40. In the example of FIG. 8, shelf 82 is beneath shelf 80. In the second configuration, the base wall 84 is substantially flush with a bottom wall 50 and the front wall 86 is substantially flush with the rear wall 46. In the second configuration, the base wall 84 serves as an effective bottom wall of the interior cavity 40.

In the first configuration, the shelf 80 is supported by two shelf supports 90, 92, each of which is arranged relative to a respective one of the first and second side walls 42, 44. The shelf supports 90, 92 are configurable between a first configuration (FIG. 9) in which the shelf supports 90, 92 project outward relative to a corresponding one of the first and second side walls 42, 44 such that the shelf 80 is able to rest upon the shelf supports 90, 92 when the shelf 80 is in the first configuration. The shelf supports 90, 92 are also configurable into a second configuration in which the shelf supports 90, 92 are substantially flush with a respective side wall 42, 44, as shown in FIG. 10. The shelf supports 90, 92 are rotatable between the first and second configurations in this example. In a particular example, the shelf supports 90, 92 are configured to rotate between the first and second configurations without otherwise moving relative to the first and second side walls 42, 44.

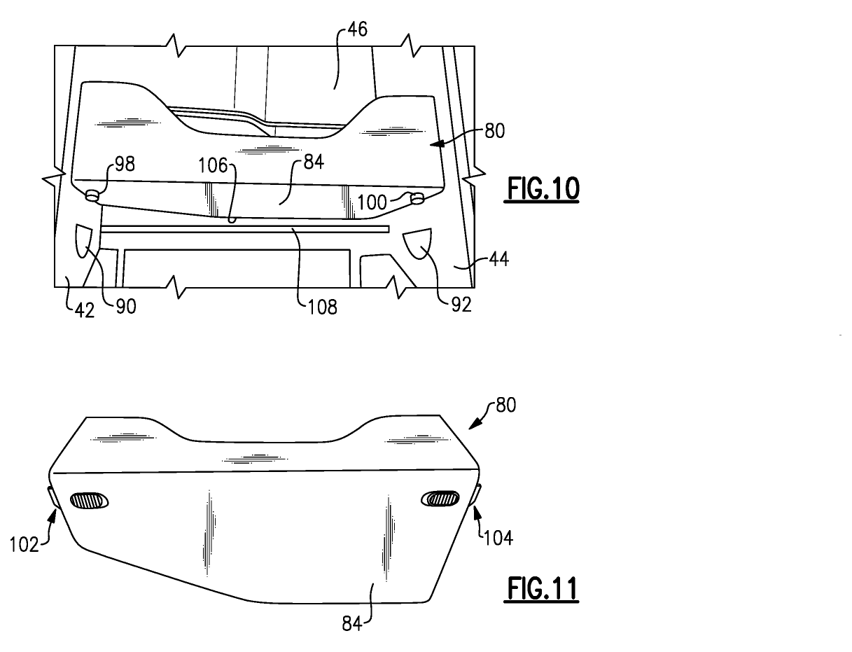

The shelf supports 90, 92 may include openings, such as through-openings 94, 96, configured to receive a corresponding projection 98, 100 formed in a bottom of the base wall 84, in some examples. Alternatively or additionally, the base wall 84 may include latches 102, 104 configured to interface with corresponding side walls 42, 44, as shown in FIG. 11.

Further, when the shelf 80 is in the first configuration, a rear edge 106 of the base wall 86 is configured to interface with a slot 108 formed in the rear wall 46 to further support the shelf 80.

The storage compartment 28 can include a number of sets of shelf supports and slots vertically spaced-apart from one another to support one or more shelves at different heights, depending on the storage requirements of a user, for example.

In another aspect of this disclosure, the second side wall 44 includes a sub-storage compartment 110 (FIG. 12) defined by an opening 112 in the second side wall 44. The opening 112 has a perimeter P2, and the sub-storage compartment includes a portion 114 (represented by dashed lines) that extends beneath the perimeter P2. In this way, the sub-storage compartment 110 exhibits a vertical lip that helps to retain items, such as a tire pressure gauge and pen, as shown in FIG. 12. The first side wall 42 or the rear wall 46 could alternatively or additionally include a similarly-configured sub-storage compartment.

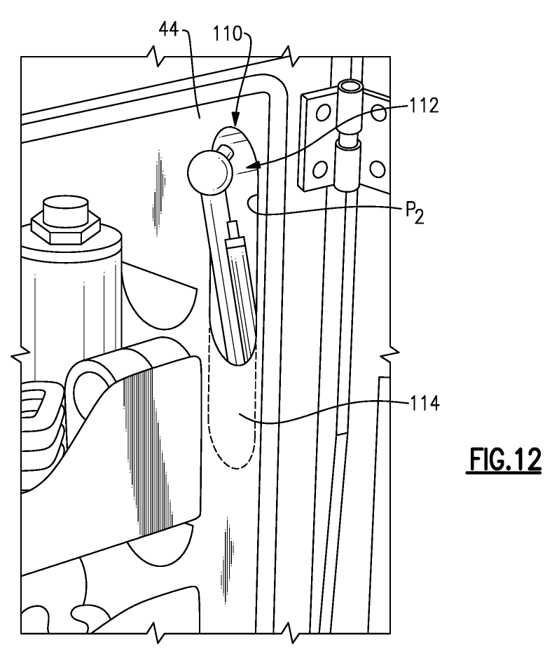

Another aspect of this disclosure relates to various accessories that can be stored within the storage compartment 28. With reference to FIG. 13, one example accessory includes a toolbox 116. The toolbox 116 includes a basket portion 118 and a handle 120. At least a portion of the basket portion 118 is arranged beneath perimeter P and is vertically aligned with the vertical lip 56, such that the vertical lip 56 serves to retain the toolbox 116 within the storage compartment 28. The handle 120 projects vertically above the vertical lip 56 to facilitate a user grasping the handle 120 to retrieve the toolbox 116. The basket portion 118 may be sized and shaped similar to the size and shape of a bottom of the interior cavity 40 to provide a snug fit and to reduce sliding of the toolbox 116.

In this embodiment, another accessory is vertically above the toolbox 116. In particular, a perforated board, which here is a peg board 122, is mounted adjacent the rear wall 46. The peg board 122 includes a pattern of holes or slots that can be used for hanging or mounting items, such as tools. The peg board 122 can be used in combination with one or more shelves.

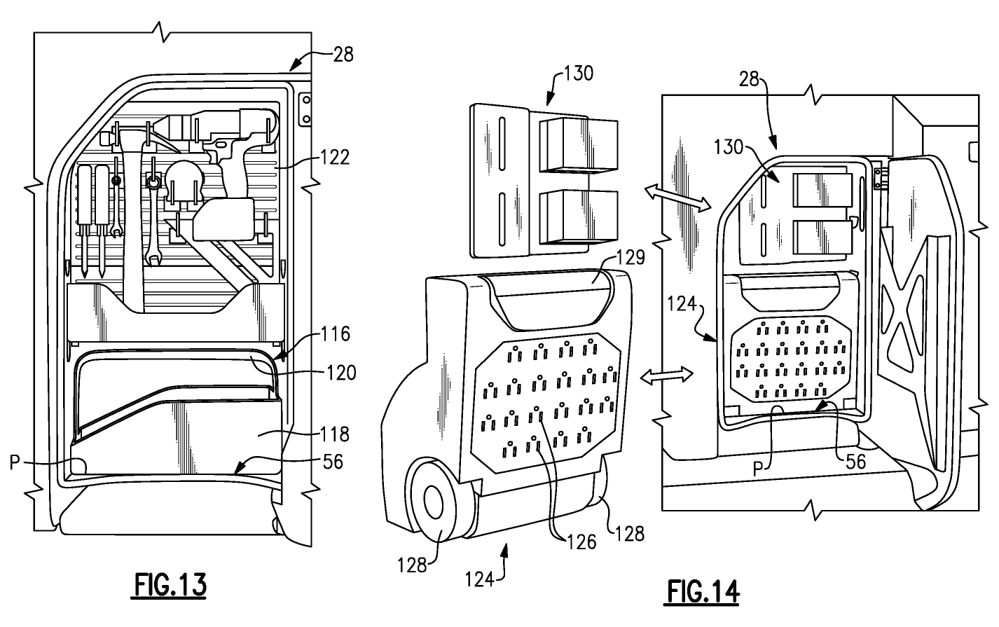

Other example accessories are shown in FIG. 14. In one embodiment, a portable battery 124 including a battery, a plurality of outlets 126, and wheels 128 is configured to fit within the storage compartment 28. In this embodiment, the portion including the wheels 128 is configured to fit in the section of the storage compartment 28 that extends beneath perimeter P. The portable battery 124 is removable from the storage compartment 28 via handle 129 of the portable battery 124. Handle 129 projects above vertical lip 56 to facilitate grasping of the handle 129 and retrieving the portable battery 124. The portable battery 124 may be chargeable when in the storage compartment 28, such as by being electrically coupled to a battery of the vehicle 10. Another example accessory includes charging ports 130 mounted adjacent rear wall 46 and configured to charge various accessories, such as batteries for various powered hand tools. The charging ports 130 may be electrically coupled to a battery of the vehicle 10.

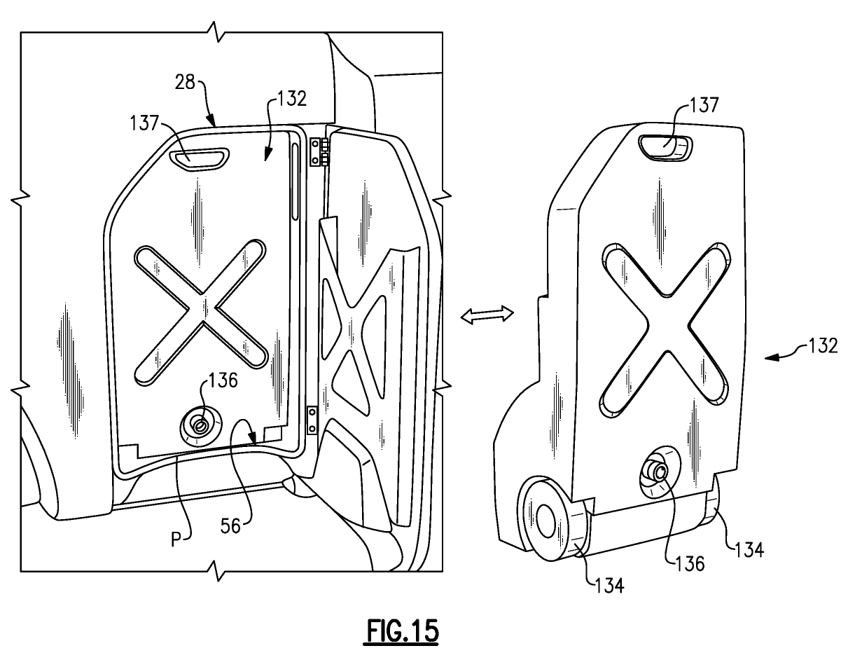

Another example accessory, as shown in FIG. 15, is a water tank 132. The water tank 132 includes wheels 134 and a nozzle 136. The water tank 132 is configured to fit within the storage compartment 28. In this embodiment, the portion including the wheels 134 is configured to fit in the section of the storage compartment 28 that extends beneath perimeter P. When the water tank 132 is in the storage compartment 28, the nozzle 136 is vertically above the vertical lip 56. The water tank 132 also includes a handle 137 above the vertical lip 56.

Other aspects of this disclosure relate to configurations of the laterally inward surface 54. In FIG. 3, the laterally inward surface 54 includes a slot 138 configured to store items, such as relatively flat items like tarps.

In another configuration, the laterally inward surface 54 supports a folding table 140 configurable between a first configuration (FIG. 16) in which the folding table 140 is configured for use as a table and a second configuration in which the folding table 140 is stowed.

In this example, the folding table 140 includes two panels 142, 144. In the first configuration, upper surfaces (relative to when the folding table 140 is in the first configuration) of the panels 142, 144 establish a table surface substantially parallel to a ground surface G adjacent the vehicle 10. The table surface includes a groove 146, in this example, substantially following an entire perimeter of the table surface to prevent items such as pens, for example, from sliding off the table surface. The panels 142, 144 are foldable relative to one another about axis X which is substantially parallel to the forward and rearward directions of the vehicle 10. In particular, panel 144 is foldable relative to panel 142 about axis X through a range of substantially 180°.

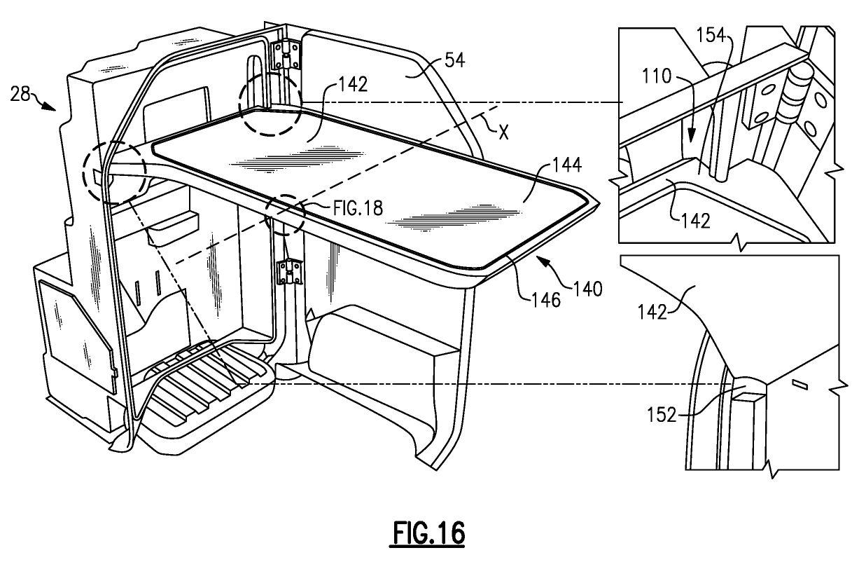

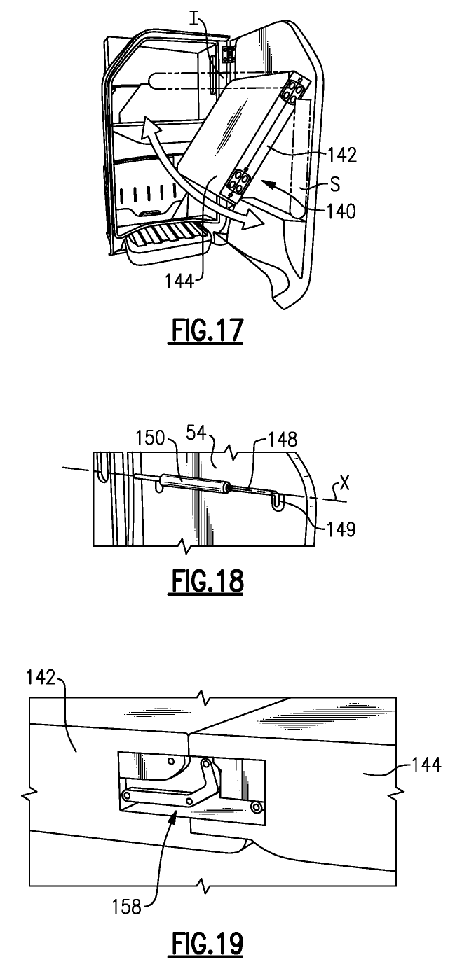

An example technique for moving (i.e., unfolding) the folding table 140 from the second configuration to the first configuration will now be described. FIG. 17 is representative of the folding table 140 being rotated from the second configuration (represented by letter S) to an intermediate configuration (represented by letter I). In FIG. 17, the panel 144 has been folded substantially 180° relative to its configuration in FIG. 16 such that the upper surfaces (relative to the first configuration) of the panels 142, 144 touch one another. The panel 142 is attached to a bar 148 (FIG. 18) received in a tube 150 attached to the laterally inward surface 54. The bar 148 extends along axis Y. When moving from the second configuration to the intermediate configuration, the panels 142, 144 and bar 148 rotate substantially 90° about axis Y. In the intermediate configuration, the panels 142, 144 and bar 148 are configured to slide along axis Y toward the interior cavity 40 such that the panel 142 interfaces with structures of the storage compartment 28, such as tab 152 (FIG. 16), and the sub-storage compartment 110, via tab 154 (FIG. 16) of panel 142, to support the panel 142 from below. When slid along the axis Y toward the storage compartment 28, a slot 149 formed in the laterally inner surface 54 may prevent rotation of the bar 148 (and in turn the panels 142, 144) about axis Y. In this position, the panel 144 can be rotated substantially 180° to the first configuration. In the first configuration, as shown in FIG. 19, adjacent the intersection of the first panel 142 and the second panel 144, at least a portion of the first panel 142 may project below the second panel 144 to support the second panel 144 from below. In another aspect, an interface of the first panel 142 and the second panel 144 may be inclined relative to a vertical direction such that at least a portion of the first panel 142 projects below the second panel 144. When in the first configuration, a hinge assembly 156 connecting the first and second panels 142, 144 may be substantially bound on all sides by at least one of the first and second panels 142, 144, as shown in FIG. 19.

It should be understood that terms such as “about,” “substantially,” and “generally” are not intended to be boundaryless terms, and should be interpreted consistent with the way one skilled in the art would interpret those terms. Further, directional terms such as “front,” “rear,” “laterally inward,” “laterally outward,” “top,” “bottom,” “side,” etc., are used for purposes of explanation only and should not otherwise be construed as limiting.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

One of ordinary skill in this art would understand that the above-described embodiments are exemplary and non-limiting. That is, modifications of this disclosure would come within the scope of the claims. Accordingly, the following claims should be studied to determine their true scope and content.

1. A motor vehicle, comprising:
a cargo box including an outer panel;
a box side step; and
a storage compartment arranged adjacent the box side step, wherein an interior of the storage compartment is selectively covered and uncovered by a door, wherein the door is moveable between a closed position and an open position, wherein, relative to when the door is in the closed position, at least a portion of a laterally outward surface of the door is recessed laterally inward of the outer panel.

2. The motor vehicle as recited in claim 1, wherein, relative to when the door is in the closed position:
a first portion of the laterally outward surface of the door is recessed laterally inward of the outer panel, and
a second portion of the laterally outward surface of the door is substantially flush with the outer panel.

3. The motor vehicle as recited in claim 2, wherein the first portion exhibits a length greater than a length of the box side step.

4. The motor vehicle as recited in claim 3, wherein:
the box side step projects partially laterally outward of a portion of the outer panel adjacent the box side step, and
relative to when the door is in the closed position, the first portion is recessed laterally inward of the outer panel such that an entire uppermost surface of the box side step is exposed.

5. The motor vehicle as recited in claim 1, further comprising a shelf configurable between a first configuration in which the shelf can be used to support items within the storage compartment, and a second configuration in which the shelf can be stowed.

6. The motor vehicle as recited in claim 5, wherein:
the storage compartment includes a shelf support configurable between a first configuration in which the shelf support projects outward relative to a side wall of the storage compartment such that a shelf is able to rest upon the shelf support when the shelf is in the first configuration, and a second configuration in which the shelf support is substantially flush with the side wall.

7. The motor vehicle as recited in claim 6, wherein:
the side wall is a first side wall of the storage compartment and the shelf support is a first shelf support, and
the storage compartment further includes a second shelf support vertically aligned with the first shelf support and configurable between a first configuration in which the second shelf support projects outward relative to a second side wall of the storage compartment such that the shelf is able to rest upon the second shelf support when the shelf is in the first configuration, and a second configuration in which the second shelf support is substantially flush with the second side wall.

8. The motor vehicle as recited in claim 7, wherein:
a rear wall of the storage compartment includes a slot, and
when the shelf is in the first configuration and supported on the first and second shelf supports, a rear edge of the shelf is received in the slot.

9. The motor vehicle as recited in claim 1, wherein:
the storage compartment includes a side wall including a sub-storage compartment defined by an opening in the side wall,
the opening has a perimeter, and
a portion of the sub-storage compartment extends beneath the perimeter.

10. The motor vehicle as recited in claim 1, wherein:
the storage compartment is defined by an opening in the outer panel,
the opening has a perimeter, and
a portion of the storage compartment extends beneath the perimeter.

11. The motor vehicle as recited in claim 10, wherein an accessory is configured to fit within the storage compartment, and wherein a portion of the accessory is configured to fit within the portion of the storage compartment below the perimeter.

12. The motor vehicle as recited in claim 11, wherein the accessory is one of a portable battery, a tool box, and a water tank.

13. The motor vehicle as recited in claim 10, wherein:
a seal extends around the perimeter, and
a laterally inward surface of the door is configured to press against the seal when the door is in the closed position.

14. The motor vehicle as recited in claim 1, further comprising a divider configurable between a first configuration in which the divider can be used to separate items within the storage compartment, and a second configuration in which the divider can be stowed in a recess in a side wall of the storage compartment.

15. The motor vehicle as recited in claim 1, wherein the storage compartment includes a battery charging port.

16. The motor vehicle as recited in claim 1, wherein the storage compartment includes a peg board.

17. The motor vehicle as recited in claim 1, wherein a laterally inward surface of the door includes a slot configured to store items.

18. The motor vehicle as recited in claim 1, wherein a laterally inward surface of the door supports a folding table configurable between a first configuration in which the table is configured for use as a table and a second configuration in which the table is stowed.

19. A motor vehicle, comprising:
a cargo box including an outer panel;
a box side step;
a storage compartment arranged adjacent the box side step, wherein the storage compartment is selectively covered and uncovered by a door, wherein the door is moveable between a closed position and an open position, wherein the storage compartment is defined by an opening in the outer panel, wherein the opening has a perimeter, and wherein a portion of the storage compartment extends beneath the perimeter.

20. A method comprising:
opening a door to uncover a storage compartment in a cargo box of a motor vehicle; and
unfolding a table mounted to a laterally inward surface of the door.
